(19) United States
(12) Patent Application Publication
(10) Pub. No.: US 2021/0115626 A1
(43) Pub. Date: Apr. 22, 2021

(54) METHOD FOR OPERATING A PAPERMAKING MACHINE, DRIVE SYSTEM AND PAPERMAKING MACHINE

(71) Applicant: Siemens Aktiengesellschaft, 80333 München (DE)

(72) Inventors: RAGNAR ARNASON, Wiesenthal (DE); MARTIN MEINARDUS, Nürnberg (DE); JÜRGEN MIELKE, Bamberg (DE); UWE WITTENDORFER, Königsbronn (DE); GERRIT WOLF, Karlsruhe (DE)

(73) Assignee: Siemens Aktiengesellschaft, 80333 München (DE)

(21) Appl. No.: 16/606,064

(22) PCT Filed: Apr. 13, 2018
(86) PCT No.: PCT/EP2018/059508

§ 371 Date: Oct. 17, 2019

(30) Foreign Application Priority Data
Apr. 18, 2017 (EP) 17166788.4

(51) Int. Cl. D21G 9/00

(52) U.S. Cl. CPC D21G 9/0036

(57) ABSTRACT

For operating a drive system or a papermaking machine, motion parameters such as a rotary speed of a motor are determined. From at least one of the motion parameters, a performance value or Key Performance Index is calculated in a motion controller and/or in a non-local computing unit. The performance value is derived from changes in the motion parameters or control parameters over time and displayed to operating personnel on a display. The performance value represents a control performance indicating a control speed responsive to a set motion parameter and thus an operating state of the papermaking machine.

The invention relates to a method for operating a papermaking machine, a drive system and a papermaking machine.

Papermaking machines normally have a large number of drives (motors, converters). For the operation of a papermaking machine, it is necessary that a plurality of the drives of the papermaking machine are coordinated in their motion parameters such as rotary speed and torque.

In the event of a fault in the operating process, according to the current state of the art, the operating personnel of the papermaking machine rapidly becomes overwhelmed by the large number of dependencies between the drives. Web breaks and stoppage times are the negative consequences.

It is therefore an object of the invention to configure the controller of a papermaking machine so that a simplified operation is enabled.

The object is achieved by means of a method according to claim 1.

This object is further achieved by means of a motion controller according to claim 10 and with a papermaking machine as claimed in claim 14.

Advantageous embodiments and developments are the subject matter of the dependent claims.

In the method for operating a papermaking machine, the papermaking machine comprises a plurality of drives and a motion controller. Herein, the drives and optionally detectors provide motion parameters for the motion controller, wherein the motion controller determines, on the basis of the motion parameters and/or the controller parameters, at least one performance value, wherein the at least one performance value defines an operating state of the papermaking machine, wherein the at least one performance value is displayed on a display, characterized in that the performance value is based upon at least one of the motion parameters or at least one controller parameter. In particular, the respective performance value is based upon the temporal change of at least one motion parameter and/or the temporal change of at least one controller parameter.

On the basis of the respective performance value, advantageously, the motion parameters and/or the controller parameters are optimized.

The optimization of the motion parameters and/or of the controller parameters advantageously takes place in that the performance value is improved or increased.

Suitable performance values can be determined by means of a benchmark method.

Preferably, performance values of different papermaking machines or parts of papermaking machines are compared with one another.

Advantageously, an adaptation of individual motion parameters and/or of controller parameters takes place on the basis of a better or higher performance value of a further papermaking machine or a part of a further papermaking machine.

Advantageously, an adaptation of the motion parameters and/or of the controller parameters takes place with the aid of artificial intelligence.

Preferably, the performance values are configured such that a plurality of parts of the respective papermaking machine are comparable.

Advantageously, a non-central computing unit, also termed a Cloud, serves for the exchange and adaptation of the respective performance value of different parts of the respective papermaking machine.

Advantageously, the controller parameters and/or motion parameters of a first papermaking machine or a first unit or part of a papermaking machine are compared with a second papermaking machine or another unit of the second papermaking machine. By means of such a comparison, a global performance value of a plurality of papermaking machines or units of papermaking machines can be formed.

Advantageously, the motion parameters and/or the controller parameters from a unit of the first papermaking machine can serve as the basis for an optimization of at least one performance value of a further papermaking machine.

In place of a papermaking machine, the invention can also serve for the improvement of the function of another industrial plant.

The drive system is configured, in particular, for a papermaking machine. The drive system comprises a plurality of drives and a motion controller, as well as a display, wherein the drives and/or detectors are configured for providing motion parameters, wherein the motion controller is provided for determining performance values from the motion parameters and/or the controller parameters, wherein the display is provided for displaying the performance values, characterized in that the performance values result from the motion parameters and/or the controller parameters, in particular, from their respective changes over time.

The invention is based upon the general concept that a display of performance values, also termed Key Performance Indicators, facilitates the operation of a papermaking machine. The operating personnel are enabled, by means of the display of the performance values, to monitor the function, the capacity utilization and/or the productivity of the papermaking machine. Performance values can be determined by individual parts of the papermaking machine. Individual parts of the papermaking machine are, for example:

an approach section,

a wire section,

a press section,

a drying section, and

a winding unit.

The display of the performance values of the aforementioned parts leads to rapid and easy monitoring of the function of the papermaking machine by the operating personnel.

By means of a comparison of individual parts, with suitable performance values, weak points in the interaction can be identified rapidly and easily.

A motion controller preferably has a programmable logic controller (PLC). Such a control device can also comprise a CPU (central processing unit), for example a SIMATIC (possibly with an additional module) from Siemens AG.

A motion parameter should be understood, for example, as the rotary speed, the torque or a deviation of an actual rotary speed from a target rotary speed. Furthermore, a load or a temperature of the respective motor can be a motion parameter.

A controller parameter should be understood, for example, as the manipulated variable of a controller. Any parameter which influences the function of the controller is suitable as the controller parameter. A controller parameter is, for example, a differential portion of the control, an integral part of the control or a feedback factor.

Preferably, from the respective controller parameters and/or their change over time, a control quality is determined. The control quality is advantageously displayed as a performance value.

The drive system usually comprises a plurality of drives, wherein the drives are coupled to one another. A drive usually comprises at least one motor and, in each case, a (frequency) converter. The coupling takes place by means of the cooperation of the motors via mechanical elements such as a conveyor belt which is driven by two motors.

In an advantageous embodiment of the method, motion parameters and/or controller parameters of two motion controllers serve, in each case, for determining the at least one performance value, wherein the motion controllers are assigned to different units of a papermaking machine.

Advantageously, the respective performance value is adapted such that different units of papermaking machines can be compared with one another.

Preferably, the controller parameters and/or the motion parameters are adapted iteratively on the basis of the respective performance value. Advantageously, the controller parameters and/or the motion parameters are iteratively adapted on the basis of those controller parameters and/or motion parameters which are provided by a unit of a papermaking machine which has an improved performance value.

Advantageously, motion parameters are provided from one unit of a papermaking machine to a further unit of a papermaking machine.

If the respective performance value can be improved by the use of the controller parameters and/or motion parameters provided, the controller parameters and/or the motion parameters of the further unit are adapted.

Thereby, a unit of the respective papermaking machine can learn from another unit of the respective papermaking machine.

Controller parameters and/or motion parameters are preferably

Hereby, parts of a papermaking machine or parts of different papermaking machines can be compared.

For example, the press section and the drying section can be compared with one another by means of respective suitable performance values.

For example, the productivity of the press section and the productivity of the drying section can be compared as a performance value.

Furthermore, the respective specific energy consumption (energy per ton of paper manufactured) of the respective drying section and of the respective press section can be compared as a performance value. A comparison of the respective specific energy consumption permits an advantageous division of the respective energy input for minimizing the overall energy consumption.

In a further advantageous embodiment of the method, the motion controllers are assigned to different papermaking machines, wherein the data transferred between motion controllers is transferred with the aid of a technical data connection, in particular via a Cloud.

By means of this embodiment, individual parts of different papermaking machines can be compared. A papermaking machine can thus check how it relates, with regard to the performance value of the specific energy consumption or the productivity, to other papermaking machines.

If the performance values differ substantially, then on the basis of a comparison of the motion parameters and/or the controller parameters, it can be analyzed how, where relevant, settings are to be changed in order to change the corresponding performance value.

Advantageously hereby, knowledge about a setting in a further papermaking machine can be used.

In addition, stored motion parameters and/or controller parameters of a motion controller can be provided. The storage preferably takes place in the Cloud.

In a further advantageous embodiment of the method, the performance values are assigned to different operating states of the respective papermaking machine.

Different operating states of the papermaking machine are, for example, settings for the production of different paper types. Different operating states can also be energy-saving modes with reduced utilization of the respective papermaking machine.

Through the definition of different operating states, motion parameters and/or controller parameters of the respective operating state can be stored and displayed to the operating personnel by reference to the performance values.

In a further advantageous embodiment of the method, the display of the performance values takes place in the form of a spider diagram, a traffic-light representation or a trend.

By means of an advantageously selected manner of the representation of the performance values, the operating personnel can discern the functional mode of the papermaking machine at a glance.

By means of the portrayal of a linkage of the individual performance values in the representation, variables linked to one another can be displayed with one another.

A trend of a performance value can be understood to be a preview established by means of a simulation. The simulation of the respective performance value preferably also takes place in the Cloud.

In particular, the performance values can be displayed in their development over time. Such a representation permits the operating personnel to establish whether a measure has the desired effect on the respective operating mode.

In a further advantageous embodiment of the method, the display of a function over time of the performance values takes place.

By means of the representation of the performance values as a function of time, for example, as a function of the operating duration of the papermaking machine, signs of wear can easily be discerned. The operating personnel can accordingly discern, on the basis of the change over time, whether and what influence a servicing of the papermaking machine or of the respective drive has.

In a further advantageous embodiment of the method, from at least one controller parameter and/or at least one motion parameter, a control quality can be determined as a performance value.

A control quality is the variable which indicates the rapidity of the control to a motion parameter that is to be set. In other words, the control quality indicates how quickly the drive makes the change from a current motion parameter to a deviating target motion parameter.

On the basis of the display of the control quality, the operating personnel can discern how well a controller is set.

In a further advantageous embodiment of the method, at least one of the performance values is

a productivity of the papermaking machine,

a control quality,

a functional stability,

an error density, or

a controller functionality.

Furthermore, performance values can be the quality of the paper, an energy consumption of a part such as the drying section, a paper density, a fiber orientation of the paper or a production quantity per unit time. Combined variables such as the energy quantity per unit of paper produced can also be performance values and can be displayed individually and in combination.

The performance values can be selected depending upon the configuration of the papermaking machine. Preferably, Individual or multiple performance values are displayed in order to configure the operating state of the papermaking machine in a manner which is recognizable at a glance.

The productivity of the papermaking machine is understood hereby to be the quantity of paper produced per unit time. Functional stability can be understood, for example, as a measure for the variation in the productivity or in the quality of the paper produced. The performance value “error density” can mean, for example, the number of web breaks per unit time.

The performance value of the controller functionality is understood to mean how stably a drive maintains its controlled motion parameter or whether a controller must adjust out deviations of the respective motion parameter in short time intervals.

In summary, the performance values provide characteristic numbers which give the operating mode of the papermaking machine or parts of the papermaking machine. With a suitable standardization, different papermaking machines can also be compared in their function, capacity utilization and quality of the setting.

Preferably, the determination and the storage of the performance values take place in a non-local computing unit or in a central server. A non-local computing unit or a central server are herein also termed a Cloud. The calculation of the performance values from the motion parameters and/or the controller parameters takes place, in particular, on the basis of the lack of capacity of the motion controller or another local control unit.

In addition, the non-local computing unit can be connected to a plurality of drive systems, in particular, of a plurality of papermaking machines. A local network (Intranet) or the Internet is suitable as a technical data connection. Preferably, an Ethernet connection or a Wi-Fi (W-LAN) connection serves to connect the drive systems.

In an advantageous embodiment of the drive system, a bus system, in particular a field bus, is provided for the provision of the motion parameters for the respective motion controller.

The bus system can be configured as a PROFIBUS or an Ethernet connection. The bus system serves for transferring the motion parameters determined by sensors or detectors and/or in the (frequency) converter to the respective motion controller. Sensors determine, for example, the temperature of the respective drive, the loading of a motor, the frequency of the respective supply voltage of the motor. The respective motion controller passes on the motion parameters to the non-local computing unit or to the Cloud or at least partially calculates the performance values determined for display.

In a further advantageous embodiment of the drive system, the drive system is connected via a technical data connection, in particular via a non-local computing unit or a Cloud, to a further drive system.

The connection of motion controllers to one another via the Cloud has the advantage that performance values, motion parameters or controller parameters of motion controllers can be exchanged with one another.

A preferred use of the invention disclosed herein is a papermaking machine. The papermaking machine preferably has a drive system described here.

In place of a papermaking machine another machine for producing a basic material, such as an oil production facility or an ore processing machine, can equally be the field of use of the invention.

In addition, the drive system can be part of a machine tool, a production machine or another industrial system.

In other words, the invention relates to a method for operating a papermaking machine and to a drive system and a papermaking machine. On operation of the drive system or on operation of the papermaking machine, motion parameters such as a rotary speed of a motor or controller parameters are determined. From at least one of the motion parameters, a performance value, also termed the Key Performance Index, is calculated in a motion controller and/or in a non-local computing unit. The at least one performance value is displayed on a display to the operating personnel of the papermaking machine. By means of the at least one displayed performance value, the operating personnel can discern the operating mode of the respective drive system or of the papermaking machine at a glance and remedy errors at an early stage.

The invention will now be described and explained in greater detail making reference to the drawings. The exemplary embodiments shown are herein not to be regarded as a restriction of the invention. Individual feature of the embodiments described can be combined to form new embodiments. In the drawings:

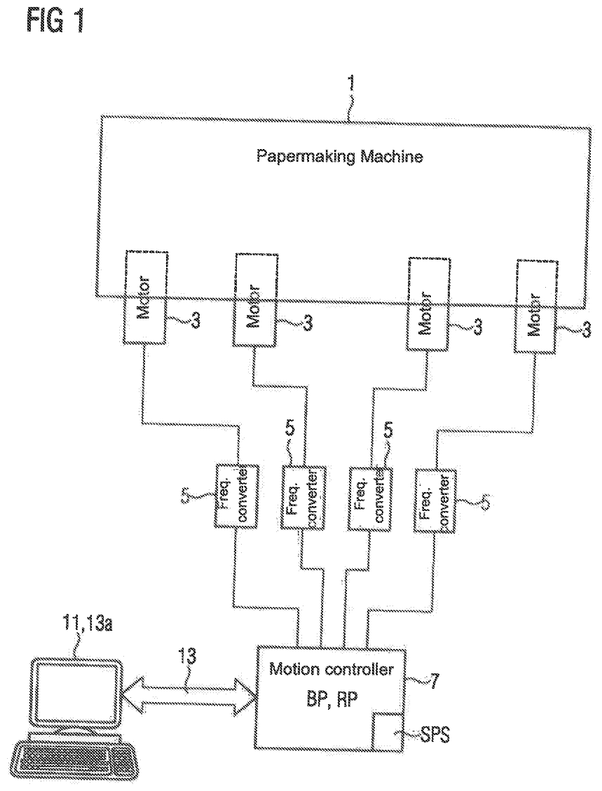

FIG. 1 shows a papermaking machine with a drive system,

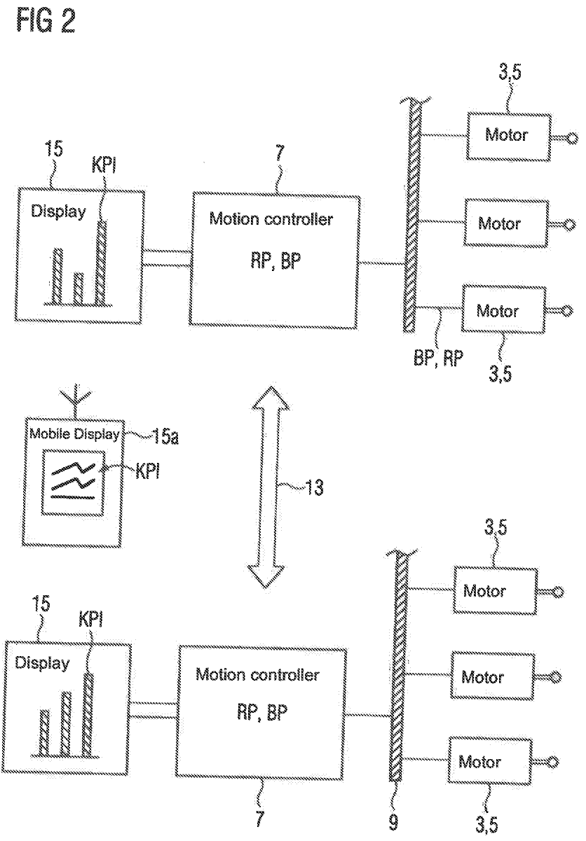

FIG. 2 shows two motion controllers with drive systems,

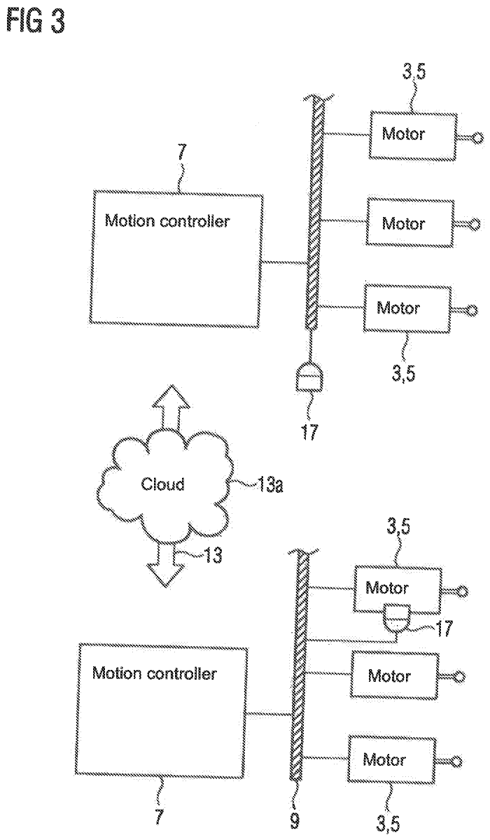

FIG. 3 shows two motion controllers, and

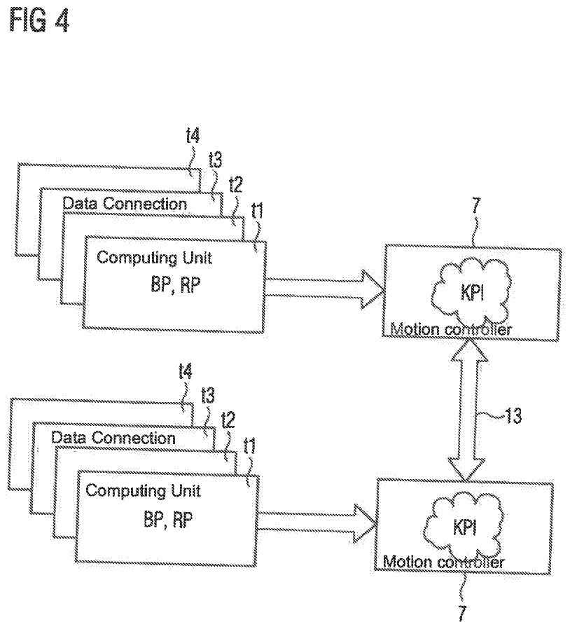

FIG. 4 shows a method for providing performance values.

FIG. 1 shows a papermaking machine 1 with a drive system. The drive system comprises a plurality of motors 3. The motors serve, for example, for driving a continuous flow of material, in particular a paper web.

Each motor 3 is connected by means of a frequency converter 5 to a motion controller 7 and/or a programmable logic controller (PLC) or a CPU, in particular a SIMATIC control device, optionally with a corresponding additional module. Preferably, a motion controller 7 comprises a programmable logic control system SPS or a CPU. The motion controller 7 receives the specifications regarding the motion parameters (rotary speed, torque, . . . ), for example from a higher-order control system, represented in this case by a computing unit 11. The connection of the higher-order computing unit 11, which can also be configured as a central server or as a Cloud 13a, takes place by means of a technical data connection 13.

The motion parameters BP of the individual motors 3 are usually coupled. The coupling of the motion parameters BP preferably takes place in the motion controller 7 and/or with the aid of the frequency converter 5.

A motion parameter BP can be a location, a web speed, a rotary speed or a torque of a drive. A motion parameter BP can also be further variables such as the temperature, a flow speed of a process medium, a web tension and/or a loading parameter.

A motion parameter BP can furthermore also be a setting of a control loop, for example, a proportional component of a PI or a PID controller.

Furthermore the motion controller 7 has at least one controller. The controller provides the controller parameter RP. The controller serves for controlling the at least one motion parameter BP.

FIG. 2 shows two motion controllers 7 with drives. Each drive comprises a frequency converter 5 and a motor 3. The drives are each connected via a bus system 9 to the motion controller 7. For example, the bus system is configured as an industrial network connection, e.g. a PROFIBUS, an EtherCAT or another Ethernet connection.

The respective motion controllers are connected to one another via a technical data connection 13, for example a higher-order network. The technical data connection 13 can also be configured via an Intranet or the Internet.

Each motion controller 7 serves to record motion parameters BP which are provided by the drive components. Each motion controller serves to calculate performance values KPI (Key Performance indices).

The performance values KPI can be displayed on a display 15. The operator of the papermaking machine (not shown) can thus draw conclusions from the performance values KPI regarding the operating state of the drive system or of the papermaking machine. A mobile display device 15a, such as a tablet computer or a mobile telephone (smartphone) is also suitable as the display 15.

Performance values KPI can be controller settings, deviations of (rotary) speeds from a pre-set rotary speed, a temperature, for example, of a component, in particular the respective motor 3.

The display of the performance values KPI serves for the rapid recognition of the operating state of the drives and/or of the papermaking machine.

An exchange of the performance values KPI serves, in particular, for comparing operating states of different regions of a papermaking machine or for the comparison of papermaking machines between one another.

FIG. 3 shows two motion controllers 7 which are connected by means of a technical data connection 7 configured as a Cloud 13a. The Cloud 13a is configured as a decentralized computing unit and as a decentralized store for the calculation of performance values KPI and for storing motion parameters BP.

The motion parameters BP are provided similarly to FIG. 3 by a plurality of drives. Each drive comprises a frequency converter 5 and a motor 3. In addition, with the aid of the bus system 9, further detectors 17 or sensors can determine motion parameters BP or other parameters and provide them to the respective motion controller 7. Detectors 17 can also be assigned to a converter 5 or a motor 3.

FIG. 4 shows a method for providing performance values KPI. The calculation of the performance values KPI takes place with the aid of the motion parameters BP provided by the drives and/or by detectors 17.

By way of example, motion parameters BP and/or controller parameters RP are provided with a time stamp t1, . . . , t4. By means of the time stamp t1, . . . , t4, the motion parameters BP are representable as a function of time.

By means of the motion parameters BP and/or the controller parameters RP, the performance values KPI are also displayable as a function of time. By means of the display of the performance values KPI as a function of time, changes in the operational flow of the machine can be generated in a clear manner.

The technical data connection 13 between the motion controllers 7 makes clear that performance values of different drives, in particular, drives of different regions of papermaking machines and even of different papermaking machines can also be compared with one another.

In summary, the invention relates to a method and a device for operating a papermaking machine 1 and to a papermaking machine 1. For this purpose, a plurality of motors 3 is connected to a motion controller 7. The motors 3, the (frequency) converters 5 and/or the detectors 17 provide motion parameters BP for the motion controller 7. From the motion parameters BP, performance values KPI are calculated, wherein the performance values indicate the operating state of the papermaking machine 1. By means of the display of the performance values KPI on a display 15, in particular on a mobile device 15a with a display 15, a user can advantageously discern the operating state of the papermaking machine. Furthermore, by means of a connection of a plurality of motion controllers 7 via a technical data connection 13, a comparison of different regions of papermaking machines 1, in particular of a plurality of papermaking machines can take place. With the invention disclosed herein, it is possible to react rapidly to negative deviations during the operation of a papermaking machine 1.

What is claimed is:

1.-14. (canceled)

15. A method for operating a papermaking machine which comprises a motion controller and a plurality of drives providing motion parameters for the motion controller, the method comprising:
controlling with at least one controller of the motion controller at least one motion parameter, and
determining with the motion controller, on the basis of the motion parameters and/or controller parameters, based on changes over time of the motion parameters and/or the controller parameters, at least one performance value representing a control performance indicating a control speed responsive to a set motion parameter,
wherein each controller parameter is a manipulated variable of the at least one controller of the motion controller and the at least one performance value indicates an operating state of the papermaking machine.

16. The method of claim 15, wherein the drives further comprise detectors providing the motion parameters for the motion controller.

17. The method of claim 15, wherein the at least one performance value is determined from motion parameters derived from two motion controllers, with each of the two motion controllers being assigned to a different unit of the papermaking machine.

18. The method of claim 17, wherein the two motion controllers are assigned to different papermaking machines and wherein data are transferred between the two motion controllers via a technical data link.

19. The method of claim 18, wherein the technical data link comprises a Cloud.

20. The method of claim 15, wherein different operating states of the respective papermaking machine have different performance values associate therewith.

21. The method of claim 15, wherein the at least one performance value is displayed in form of a spider diagram, a traffic-light representation or a trend.

22. The method of claim 15, wherein the at least one performance value Is displayed as a function of time.

23. The method of claim 15, wherein the at least one performance values is
a productivity of the papermaking machine,
a functional stability (runability),
a fault occurrence (e.g. web breaks per hour), or
a controller functionality.

24. The method of claim 15, wherein the at least one performance value is determined from a plurality of motion parameters and/or controller parameters in a non-local computing unit.

25. The method of claim 24, wherein the non-local computing unit resides in a Cloud.

26. A drive system, comprising:
a plurality of drives and detectors providing motion parameters,
a motion controller comprising at least one controller controlling at least one motion parameter and determining a performance value from the at least one motion parameter, wherein the performance value results from changes over time of the at least one motion parameter and indicates a control speed responsive to a set motion parameter, and
a display displaying the performance value.

27. The drive system of claim 26, further comprising a bus system connecting plural motion controllers and providing the motion parameters to a respective motion controller.

28. The drive system of claim 27, wherein the bus system comprises a Field-Bus.

29. The drive system of claim 26, wherein the drive system is connected via a technical data connection to a further drive system.

30. The drive system of claim 26, wherein the drive system is connected to a further drive system via a Cloud.

31. The drive system of claim 26, wherein the display is a mobile display.

32. A papermaking machine, comprising a drive system, said driving system comprising a plurality of drives and detectors providing motion parameters, a motion controller comprising at least one controller controlling at least one motion parameter and determining a performance value from the at least one motion parameter, wherein the performance value results from changes over time of the at least one motion parameter and indicates a control speed responsive to a set motion parameter, and a display displaying the performance value.
